(19) United States
(12) Patent Application Publication
(10) Pub. No.: US 2017/0054597 A1
(43) Pub. Date: Feb. 23, 2017

(54) MULTI-COMPUTER SYSTEM, MANAGER, AND COMPUTER-READABLE RECORDING MEDIUM HAVING STORED THEREIN A MANAGING PROGRAM

(71) Applicant: FUJITSU LIMITED, Kawasaki-shi (JP)

(72) Inventors: HIDEAKI MAEDA, Kawasaki (JP); Takeshi Kozuki, Kawasaki (JP)

(21) Appl. No.: 15/222,986

(22) Filed: Jul. 29, 2016

(30) Foreign Application Priority Data
Aug. 20, 2015 (JP) 2015-162470

(51) Int. Cl. H04L 12/24; H04L 29/08

(52) U.S. Cl. CPC H04L 41/084; H04L 67/34; H04L 41/0853

(57) ABSTRACT

A multi-computer system includes a plurality of computers including a first computer and a second computer associated with the first computer, the first computer including: a first setting information manager that controls storing of setting information of the first computer into a memory included in the first computer; a second setting information manager that controls storing of a copy of setting information of the second computer into the memory; and an associated information manager that controls storing of association information representing one or more associated computers associated with each of the plurality of computers into the memory. This configuration reduces a storage capacity for storing setting information.

### CROSS-REFERENCE TO RELATED APPLICATION

This application is based upon and claims the benefit of priority of the prior Japanese Patent application No. 2015-162470, filed on Aug. 20, 2015, the entire contents of which are incorporated herein by reference.

### FIELD

The embodiment discussed herein is directed to a multi-computer system, a manager, and a computer-readable recording medium having stored therein a managing program.

### BACKGROUND

On a typical server computer, a Basic Input Output System (BIOS), firmware for a Baseboard Management Controller (BMC), and others are installed in order to function the system.

In relation to the operation of such BIOS and firmware (hereinafter collectively called “firmware”), setting information stored in a non-volatile memory mounted on a system board is read and then used at the start of the device, for example.

When the system board is to be replaced due to, for example, a system failure, the above setting information needs to be evacuated from the system board to be removed and then restored into the replacement system board.

In a traditional server computer, one of the known schemes saves the setting information in a non-volatile memory, being separately provided from the system board and being in the form of a small substrate, and automatically restores the setting information into a replacement system board.

In addition, recent improvement in reducing power consumption and also in producing process of principal components, such as a Central Processing Unit (CPU), of a server computers enhances the integration and size reduction of a computer chip. This also accelerates the size reduction and highly integration of a server computer. For example, devices called a blade server and a multi-node server composed of multiple server nodes accommodated in the same casing have appeared.

The above multi-node server and the like adopt a scheme that stores setting information of each server nodes in a small-substrate non-volatile memory being separately provided from the server node.
[Patent Literature 1] Japanese Laid-Open Patent Publication No. 2003-92602
[Patent Literature 2] Japanese Laid-Open Patent Publication No. 2006-260330

In a multi-node server composed of multiple server nodes accommodated in a single casing as an example of the above traditional server computer, it is necessary to reserve a storage region having a capacity able to storing setting information of all the server nodes on a small substrate, so that the setting information of the multiple server nodes is stored in a single small substrate.

Even if the size of the computer of a server nodes is reduced, data amount of setting information per computer is not reduced. In contrast to the above, the size of server would be further reduced in future and the number of server nodes to be accommodated in a single casing would increase. It is clear that this would increase the necessary capacity to store setting information.

When the number of server nodes is to be increased in further under a state where the non-volatile memory on a small substrate has an insufficient capacity, the setting information of some of the server nodes would not be stored. On the other hand, if a non-volatile memory prepare a capacity for the maximum number of accommodatable server nodes or more in anticipation of future system expansion, the system would have a superfluous non-volatile memory, which means waste in view of the number of parts, mounting area, and manufacturing cost.

### SUMMARY

According to an aspect of the embodiment, a multi-computer system includes a plurality of computers including a first computer and a second computer associated with the first computer, the first computer including: a first setting information manager that controls storing of setting information of the first computer into a memory included in the first computer; a second setting information manager that controls storing of a copy of setting information of the second computer into the memory; and an associated information manager that controls storing of association information representing one or more associated computers associated with each of the plurality of computers into the memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating the hardware configuration of a computer according to an example of a first embodiment;

FIG. 2 is a diagram illustrating an example of information to be stored in a non-volatile memory included in a computer system of an example of the first embodiment;

FIG. 3 is a block diagram schematically illustrating an example of the hardware configuration of a BMC included in a computer system of an example of the first embodiment;

FIG. 4 is a diagram illustrating the functional configuration of a BMC of a computer system of an example of the first embodiment;

FIG. 5 is a diagram illustrating an example of server node information of a computer system of an example of the first embodiment;

FIG. 6 is a diagram illustrating an example of provisional server node information of a computer system of an example of the first embodiment;

FIG. 7 is a diagram illustrating an example of provisional server node information of a computer system of an example of the first embodiment;

FIGS. 8A-8D are diagrams denoting an example of a process of verifying local node setting information by a local node setting information manager included in a computer system of an example of the first embodiment;

FIG. 9 is a diagram denoting an example of local node setting information and foreign node setting information in a computer system of an example of the first embodiment;

FIG. 10 is a flow diagram denoting a process performed by a BMC included in a computer system of an example of the first embodiment;

FIG. 11 is a flow diagram denoting a process performed by a BMC included in a computer system of an example of the first embodiment;

FIG. 12 is a flow diagram denoting a process performed by a BMC included in a computer system of an example of the first embodiment;

FIG. 13 is a flow diagram denoting a process performed by a BMC included in a computer system of an example of the first embodiment;

FIG. 14 is a diagram illustrating a flow of data received and transmitted in a BMC of a computer system of an example of the first embodiment;

FIG. 15 is a diagram illustrating a flow of data received and transmitted in a BMC of a computer system of an example of the first embodiment;

FIG. 16 is a diagram illustrating a flow of data received and transmitted in a BMC of a computer system of an example of the first embodiment;

FIG. 17 is a diagram illustrating a flow of data received and transmitted in a BMC of a computer system of an example of the first embodiment;

FIG. 18 is a diagram illustrating a flow of data received and transmitted in a BMC of a computer system of an example of the first embodiment;

FIG. 19 is a diagram illustrating a flow of data received and transmitted in a BMC of a computer system of an example of the first embodiment;

FIG. 20 is a diagram illustrating a flow of data received and transmitted in a BMC of a computer system of an example of the first embodiment;

FIG. 21 is a diagram illustrating a flow of data received and transmitted in a BMC of a computer system of an example of the first embodiment;

FIG. 22 is a diagram illustrating a flow of data received and transmitted in a BMC of a computer system of an example of the first embodiment; and

FIG. 23 is a diagram illustrating a flow of data received and transmitted in a BMC of a computer system of an example of the first embodiment.

### DESCRIPTION OF EMBODIMENT(S)

Hereinafter, description will now be made in relation to a multicomputer system, a manager, and a managing program of a first embodiment by reference to the accompanying drawings. However, it should be noted that the following embodiment is an example, and there is no intention to exclude modifications and application of techniques that are not mentioned in the following embodiment and a modification thereof. In other words, the following embodiment and modification can be changed or modified without departing from the concept of the present invention. The accompanying drawings may further include elements and functions not appearing therein in addition to those appearing therein.

(A) Configuration:

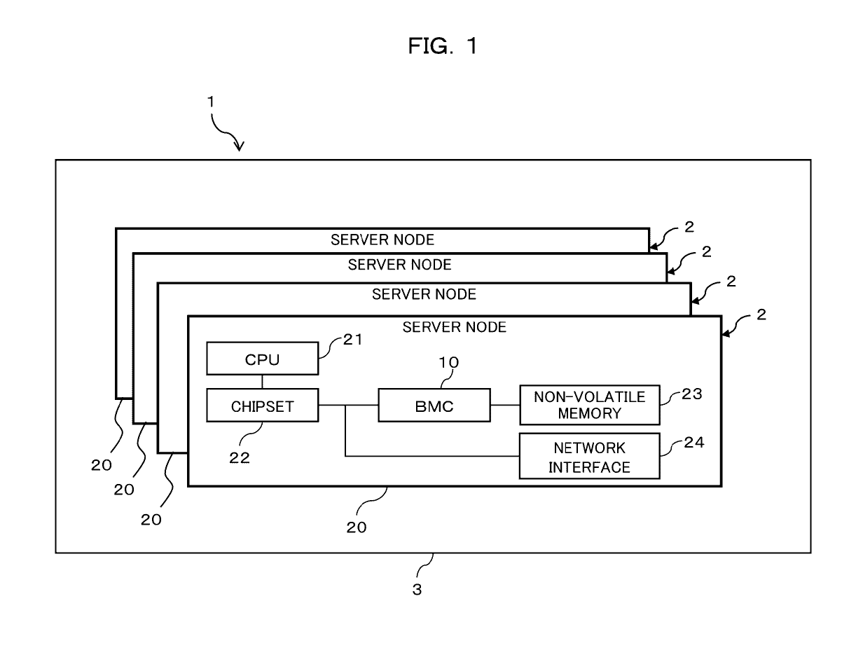

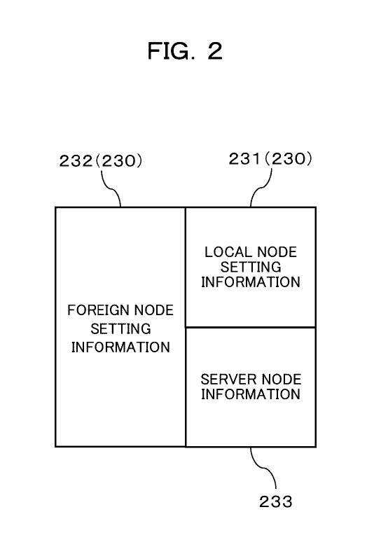

FIG. 1 is a diagram illustrating the hardware configuration of a computer system 1 according to a first embodiment; and FIG. 2 is a diagram illustrating an example of information stored in a non-volatile memory 23 of the computer system 1 of the first embodiment.

As illustrated in FIG. 1, the computer system 1 of the first embodiment includes multiple server nodes (computers) 2, which are accommodated in the same casing 3. This means that the computer system 1 is a multi-computer system composed of multiple computers and has a configuration of a blade server or a multi-node server.

Each server node 2 includes a CPU 21, a chipset 22, a non-volatile memory 23, a network interface 24, and a BMC 10, which are mounted on the system board 20.

The CPU 21 is a processor in charge of various controls and calculations and achieves various functions by executing the OS and software stored in the non-volatile memory 23.

In the illustrated in the example of FIG. 1, the system board 20 includes a single CPU 21. However, the first embodiment is not limited to this configuration, and a single system board 20 may include multiple CPUs 21.

The chipset 22 is a group of circuits that manages data transmission and reception among the CPU 21, the BMC 10, and the non-volatile memory 23.

The non-volatile memory 23 is a memory device that stores therein data, for example, and is used as an auxiliary memory device for the CPU 21 and the BMC 10. In the non-volatile memory 23, the OS program, application programs, and various pieces of data are stored. Alternatively, semiconductor memory device (Solid State Drive (SSD)) such as a flash memory may be used as the auxiliary memory.

As illustrated in FIG. 2, server node information 233, node setting information 230 (local node setting information 231 and foreign node setting information 232 are stored in the non-volatile memory 23.

The local node setting information 231, the foreign node setting information 232, and the server node information 233 will be detailed below.

The server node 2 further includes a non-illustrated Random Access Memory (RAM). A RAM is a storage region that stores therein various pieces of data and programs. In executing the OS and a program, the CPU 21 stores and expands the data and the program in the RAM.

The network interface 24 communicably connects the local server node 2 with a foreign server node 2 through communication path, and is exemplified by a Local Area Network (LAN) card.

The system board 20 is a manager device that monitors the state of the hardware in the computer system 1. The BMC 10 is supplied with electric power independently of the power supply to the CPU 21 and continuously monitors the state of the hardware in the computer system 1.

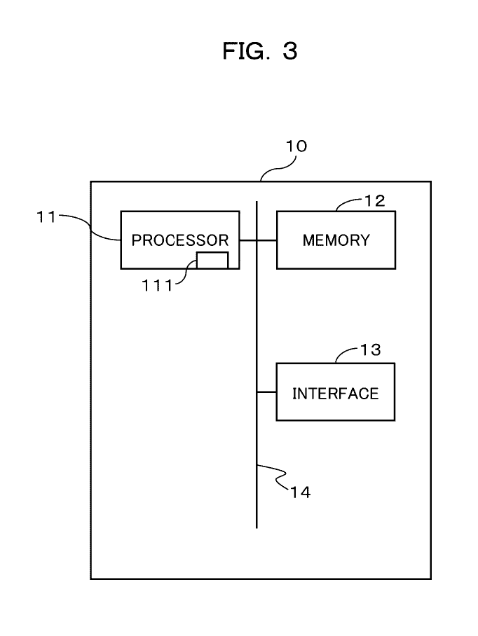

First, description will now be made in relation to the hardware configuration of the BMC (manager) 10 that achieves the function for managing setting information according to the first embodiment. FIG. 3 is a block diagram schematically illustrating an example of the hardware configuration of the BMC 10 included in the computer system 1 of the first embodiment.

The BMC 10 includes, for example, a processor 11, a memory 12, and an interface 13, which are communicably connected to one another via a bus 14.

The processor 11 controls the entire BMC 10. The processor 11 may be a multiprocessor. Examples of the processor 11 are a CPU, a Micro Processing Unit (MPU), a Digital Signal Processor (DSP), an Application Specific Integrated Circuit (ASIC), a Programmable Logic Device (PLD), and a Field Programmable Gate Array (FPGA). Alternatively, the processor 11 may be a combination of at least two of a CPU, a MPU, a DSP, an ASIC, a PLD, and an FPGA.

The processor 11 includes a register that retains calculation and a state of executing. In this embodiment, part of the register function as a master/slave register 111 (see FIG. 3) in which a value indicating whether the local server node 2 is a master node or a slave node is set. The function of the master/slave register 111 may be disposed outside the processor 11, i.e., in the CPU 21 or the memory 12.

The memory 12 is used as the main memory device of the BMC 10. In the memory 12, at least part of the OS and application programs to be executed by the processor 11 are temporarily stored. In addition, various pieces of data to be used in processes by the processor 11 are also stored in the memory 12. The application programs may include a managing program that the processor 11 is to execute in order to allow the BMC 10 to achieve the function of managing setting information of the first embodiment.

The interface 13 is a communication interface to connect an external device to the BMC 10. The interface 13 is exemplified by an I2C interface and is connected to, for example, a non-illustrated Peripheral Component Interconnect Express (PCIe) switch included in the server node 2 via a bus.

The BMC 10 having the above hardware configuration can achieve the function for managing setting information of the first embodiment as to be detailed below.

Here, the BMC 10 achieves the function for managing setting information of the first embodiment by executing a program (e.g., a managing program) stored in, for example, a non-transitory computer-readable recording medium. A program that describes the contents of processing to be executed by the BMC 10 can be stored in a various recording media. For example, the program to be executed by the BMC 10 may be stored in the non-volatile memory 23. The processor 11 loads at least one or more of the programs stored in the non-volatile memory 23 into the memory 12 and executes the loaded programs.

A program to be executed by the BMC 10 (the processor 11) may be recorded in a non-transitory portable recording medium, such as an optical disk, a memory device, and a memory card. A program stored in a portable recording medium may be installed in a non-illustrated memory device such as a Hard Disk Drive (HDD) and then comes ready to be executed under the control of, for example, the processor 11. Alternatively, the processor 11 may read the program directly from the portable recording medium and then execute the program.

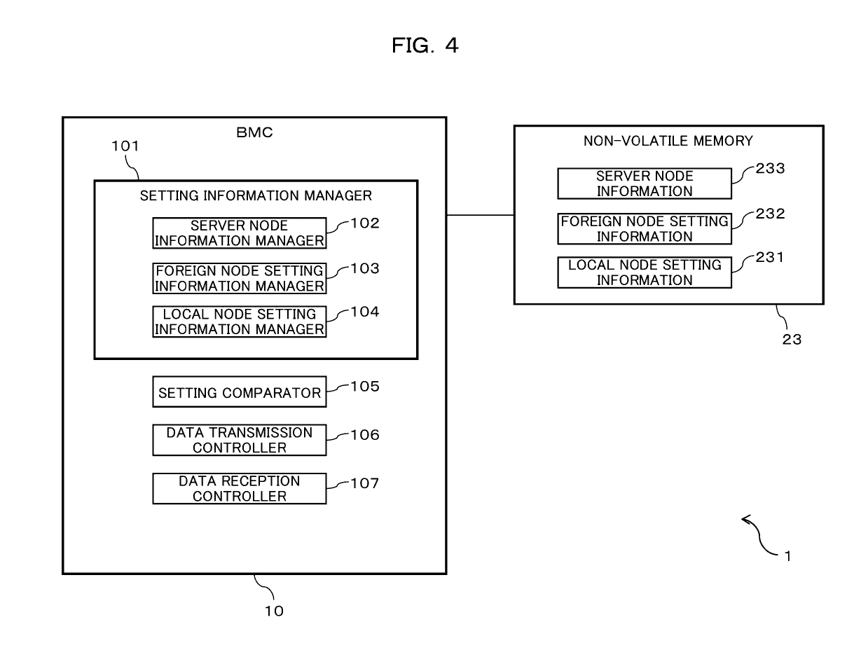

Next, by referring to FIG. 4, description will now be made in relation to the functional configuration of the BMC 10 which has the function for managing setting information of the first embodiment. FIG. 4 is a diagram illustrating a functional configuration of the BMC 10 of the computer system 1 of the first embodiment.

As illustrated in FIG. 4, the BMC 10 has the functions as at least a setting information manager 101, a setting comparator 105, a data transmission controller 106, and a data reception controller 107.

The data transmission controller 106 controls transmission of various pieces of data and commands to another server node 2 (foreign server node). For example, the data transmission controller 106 controls transmission of, for example, a provisional Identification (ID) packet, slave agreement notification, a setting clearing command, server node information, a master promoting request, slave transition notification, table updating completion notification, request for providing foreign node setting information, and setting information updating notification to another server node 2 as to be detailed below.

The data transmission controller 106 transmits the above pieces of data and commands to another server node 2 via the network interface 24 included in the local server node 2.

At a firmware initial setting stage when the local server node 2 that mounts thereon the BMC 10 on which the own data transmission controller 106 functions is making the initial setting on the firmware, the data transmission controller 106 transmits, in obedience to an instruction from the server node information manager 102, a packet (provisional ID packet) to which a provisional ID that is the peculiar information previously registered therein is provided as the identification information to the remaining server nodes 2 accommodated in the computer system 1.

Since the BMC 10 continuously functions with the supplied electric power, the firmware initial setting stage starts, for example, upon Alternating-Current (AC) power on the computer system 1. Hereinafter, the firmware initial setting stage is sometimes referred to as an initialization phase.

The data reception controller 107 controls reception of various pieces of data and commands from another server node 2. For example, the data reception controller 107 controls reception of, for example, a provisional ID issuing packet, slave agreement notification, setting clearing command, server node information, a master promoting request, slave transition notification, table updating completion notification, a request for providing foreign node setting information, and setting information updating notification sent from another server node 2.

The data reception controller 107 receives the above pieces of data and commands via the network interface 24 included in the local server node 2.

The setting comparator 105 compares the local node setting information 231 stored in the non-volatile memory 23 with setting information sent from each of multiple (two in this example) server nodes (associated server nodes) 2 in obedience to an instruction from the local node setting information manager 104 to be described below.

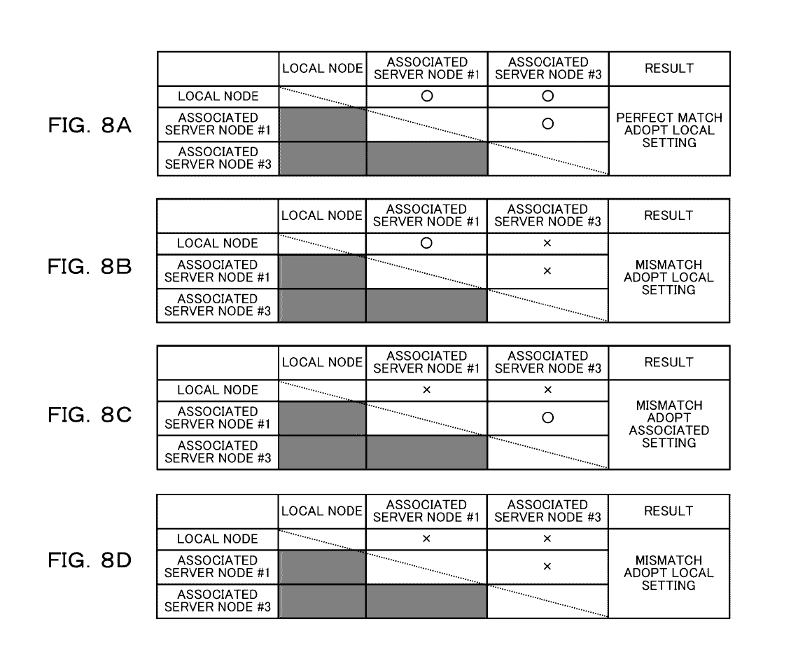

Specifically, as to be detailed below by referring to FIGS. 8A-8D, the setting comparator 105 compares local node setting information 231 and the setting information sent from each of the two associated server nodes 2 on the basis of a round-robin system and determines the agreement and disagreement between the information.

The setting comparator 105 notifies the local node setting information manager 104 of the result of the comparison.

The setting information manager 101 manages setting information and has the functions as a server node information manager 102, a foreign node setting information manager 103, and the local node setting information manager 104.

The server node information manager 102 manages information related to the server nodes 2 included in the computer system 1 by using the server node information 233.

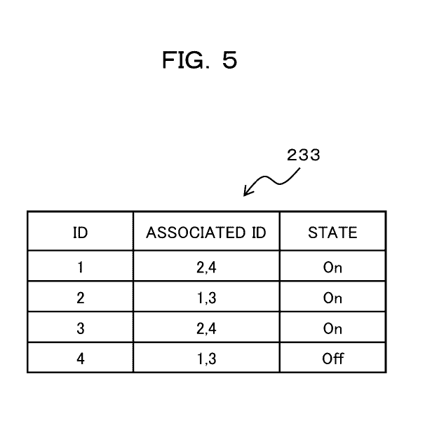

FIG. 5 is a diagram illustrating an example of the server node information 233 of the computer system 1 of the first embodiment.

As illustrated in FIG. 5, the server node information 233 includes management items representing ID information, an associated ID, and a state in association with one other.

The ID information specifies a server node 2 included in the computer system 1. In the example of FIG. 5, the integers 1-4 are registered to be the ID information. This means that the server node information 233 of FIG. 5 manages four server nodes 2 specified by the IDs of 1, 2, 3, and 4.

The state represents a state of being activated or powered on of the corresponding server node 2. In the server node information 233 of FIG. 5, the items of “On” or “Off” are registered as the state. For example, FIG. 5 indicates that the server node 2 having an ID=2 is in the state of being powered on (being activated) and the server node 2 having an ID=3 is in the state of being powered off (being inactivated).

The state “On” represents that the corresponding server node 2 is in a normal state while the item “Off” represents that the corresponding server node 2 is in an abnormal state.

The associated ID represents another (foreign) server node 2 associated with the corresponding server node 2. In the example of FIG. 5, two server nodes 2 having IDs=1, 3 are associated with the server node 2 having an ID=2.

Namely, the server node information 233 functions as association information representing one or more associated server nodes 2 with each of the server nodes 2 included in the computer system 1.

A copy of the setting information of a server node 2 identified by the ID number is stored as the foreign node setting information 232 in two server nodes 2 associated with the server node 2 in question.

In the example of FIG. 5, a copy of the setting information of the server node 2 specified by an ID=2 is stored as the foreign node setting information 232 into the two server nodes 2 identified by IDs=1, 3.

Hereinafter, a foreign server node 2 that stores therein the setting information of the server node 2 is sometimes referred to as an associated server node 2. The two server nodes 2 identified by IDs=1, 3 correspond to the associated server nodes 2 with the server node specified by an ID=2.

The server node information manager 102 functions as an associated information manager that controls storing of association information (server node information 233) representing one or more associated server nodes 2 associated with each server node 2 into the non-volatile memory 23.

In the first embodiment, each server node 2 is associated with two server nodes 2. However, the number of associated server nodes 2 is not limited to this. Alternatively, each server node 2 may be associated with one, three, or more server nodes 2.

Setting two or more associated server nodes 2 for a single server node 2 keeps the redundancy of the copy of the setting information of the single server node 2 in the computer system 1 and therefore enhances the reliability of the computer system 1.

In the example of FIG. 5, a copy of the setting information of the server node 2 having an ID=2 is stored in the server nodes 2 having IDs=1, 3. Likewise, a copy of the setting information of the server node 2 having an ID=1 is stored in the server nodes 2 having IDs=2, 4; and a copy of the setting information of the server node 2 having an ID=3 is stored in the server nodes 2 having IDs=2, 4.

Namely, the server node 2 having an ID=2 stores therein setting information of the associated server nodes 2 having the IDs=1, 3. With this configuration, a server node 2 and its associated server node 2 establishes a complementary relationship in which each server node 2 retains a copy of information of the counterpart server node 2.

In this embodiment, storing a copy of the setting information of a server node 2 into its associated server nodes 2, part of the server nodes 2 included in the computer system 1, can dispersedly stores the setting information in the computer system 1. This can eliminate the need for preparing a large-capacity non-volatile memory to store setting information of all the server nodes 2 included in the computer system 1, so that the cost for the device can be reduced.

The associated server node 2 with each server node 2 is determined by the server node information manager 102 of a master server node 2 in the initialization phase, and the determination is notified to the remaining server nodes 2 included in the computer system 1. The way of determining of an associated server node 2 with a server node 2 is not particularly limited. For example, an associated server node 2 may be determined by arbitrarily selected one among the multiple server nodes 2 included in the computer system 1 or on the basis of a certain rule, such as position in the slot of each server node 2 in the casing 3 or the order of installing the server node 2 in the casing 3. The determination may be variously modified.

In the initialization phase, the server node information manager 102 confirms whether server node information 233 is stored in the non-volatile memory 23 of the server node 2 (local server node 2) that includes the BMC 10 on which the server node information manager 102 in question functions.

When server node information 233 is not stored in the non-volatile memory 23 of the local server node 2, the server node information manager 102 causes the data transmission controller 106 to issue a provisional ID packet and a request for providing the server node information 233 to a foreign server node 2.

If any foreign server node 2 does not respond to the request for providing the server node information 233, which means that the foreign server node 2 is also in the initialization phase, the server node information manager 102 carries out a procedure to promote the local server node 2 to a master node in order to update the server node information 233 of the local and foreign server nodes 2. Specifically, the server node information manager 102 transmits a request (master promoting notification, a request for promoting to a master) declaring promoting to a master to all the remaining server nodes 2 included in the computer system 1. If receiving slave agreement notification from all the remaining server nodes 2, the server node 2 is promoted to the master node and its server node information manager 102 sets a value representing that the server node 2 is to function as a master node in the master/slave register 111.

On the other hand, the remaining server nodes 2, which have received the master promoting notification from another server node 2, are not promoted to a master node and are to function as slave nodes. For this purpose, the server node information manager 102 of each remaining server node 2 sets a value representing that the server node 2 is to function as a slave node 2 in the master/slave register 111.

As described the above, when server node information 233 is not registered in the initialization phase, which means that all the server nodes 2 are in initialization phase, each server node 2 issues a provisional ID packet to foreign server nodes 2 in the computer system 1 of the first embodiment.

The server node information manager 102 grasps the configuration (e.g., the number) of server nodes 2 accommodated in the casing 3 on the basis of the provisional IDs received from foreign server nodes 2.

The master server node 2 collects the provisional ID packets issued from the foreign server nodes 2 through the data reception controller 107 and generates provisional server node information 233a.

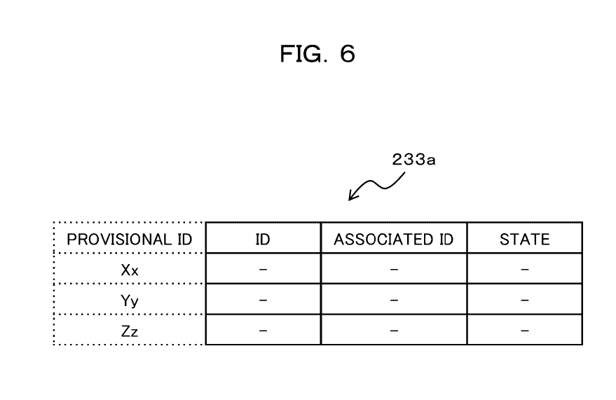

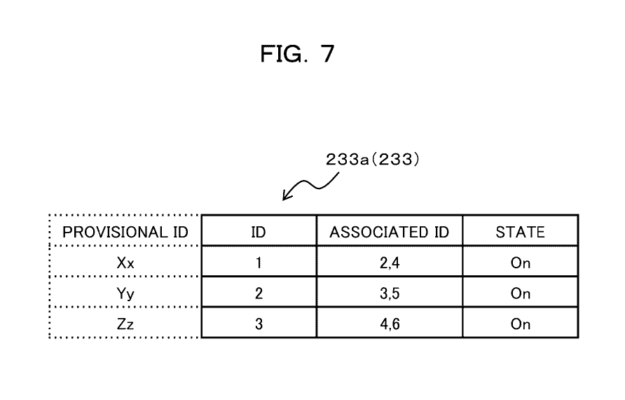

FIGS. 6 and 7 are diagrams illustrating examples of the provisional server node information 233a of the computer system 1 of the first embodiment. FIG. 6 illustrates an example of the provisional server node information 233a in which only provisional IDs are registered; and FIG. 7 illustrates an example of the provisional server node information 233a in which ID information, associated IDs, and states are registered in addition to provisional IDs.

The provisional server node information 233a includes provisional IDs in addition to the management items of the server node information 233 of FIG. 5. Into the item of the provisional ID, a provisional ID extracted from a provisional ID packet received from each foreign server node 2 is registered. In the accompanying drawings, like management items designate the same or substantially same items described above, so repetitious description is omitted here.

In the provisional server node information 233a at the time point when being generated by the server node information manager 102, only the provisional IDs are registered while ID information, associated IDs and states are blank (“-”) (see FIG. 6).

Then the server node information manager 102 generates server node information 233 on the basis of the provisional server node information 233a.

For example, the server node information manager 102 definitely provides an ID (ID information) to each provisional ID and sets one or more associated IDs for each ID. Namely, the server node information manager 102 sets, for each server node 2, one or more associated server nodes 2 that are to store therein the setting information of the server node 2. In addition, the server node information manager 102 sets a powering-on state of each server node 2 in the item “state” (see FIG. 7).

After that, the server node information 233 is generated by removing the provisional IDs from the provisional server node information 233a.

The server node information manager 102 distributes the generated server node information 233 to all the remaining server nodes 2 via the data transmission controller 106.

In each slave server nodes 2, the server node information manager 102 updates the server node information 233 being stored in the local non-volatile memory 23 with the server node information 233 received from the master server node 2.

The server node information manager 102 further has a function for alive monitoring on foreign server nodes 2, specifically associated server nodes 2, using the server node information 233.

Alive monitoring confirms whether a foreign server node 2 is normally operating. For this purpose, the server node information manager 102 transmits a command to an associated server node 2, for example. When the associated server node 2 responds to the transmitted command, the associated server node 2 is determined to be in a normal state. In contrast, when the associated server node 2 does not respond to the transmitted command, the server node 2 is determined to be in an abnormal state.

The server node information manager 102 updates the item of the state (On or Off) in the server node information 233 on the basis of the result of the alive monitoring (normal or abnormal state). The server node information manager 102 broadcasts the ID of a server node 2 determined to be abnormal and information (state changing notification) indicating that the server node 2 is in the abnormal state to all the server nodes 2 in the computer system 1.

The server node information manager 102 sends, for example, “IDx=Off” as the information indicating that the server node 2 is in an abnormal state. The term IDx represents the ID of the server node 2 determined to be in the abnormal state.

In a server node 2 that has received the state changing notification, the server node information manager 102 updates the server node information 233 stored in the non-volatile memory 23 in obedience to the received state changing notification.

Such updating of the “state” in the server node information 233 by the server node information manager 102 makes it possible grasp the state of replacing and increasing server nodes 2 in the computer system 1. In cases where the server node information manager 102 detects that a server node 2 is in the abnormal state as a result of the alive monitoring, the server node information manager 102 broadcasts the state changing notification to the foreign server nodes 2, so that the server node information manager 102 of each server node 2 actively restores the failure and reconstructs the server node information 233 accompanied by installation of another server node 2.

The local node setting information manager 104 manages the local node setting information 231, which is the setting information of the server node 2 (local server node 2) including the BMC 10 on which the local node setting information manager 104 in question functions.

For example, the local node setting information manager 104 stores the local node setting information 231 in a predetermined region of the non-volatile memory 23. The local node setting information manager 104 reads the local node setting information 231 from the non-volatile memory 23 and transmits the read local node setting information 231 to the two associated server nodes 2 via the data transmission controller 106. Each associated server node 2 stores the received setting information as foreign node setting information 232.

Thereby, a copy of the setting information (local node setting information 231) of the server node 2 is stored, as the foreign node setting information 232, in the two associated server nodes 2 thereof.

The local node setting information manager 104 further has a function of verifying whether the local node setting information 231 stored in the non-volatile memory 23 is correct.

For example, the local node setting information manager 104 verifies whether the local node setting information 231 is correct when the computer system is started or restarted.

The local node setting information manager 104 requests, by reference to the server node information 233, each associated server node 2 specified by an associated ID to transmit the foreign node setting information 232 stored in the associated server node 2 (asks each associated server node 2 for the foreign node setting information 232). Then the associated server node 2 receives the request and respond to the local node setting information manager 104 with the foreign node setting information 232 stored therein.

After that, the local node setting information manager 104 causes the setting comparator 105 to compare the values of the local node setting information 231 stored in the non-volatile memory 23 and the values (setting information) concerning the local server node 2, the values being included in the foreign node setting information 232 received from each associated server node 2.

As a result of the comparison in the setting comparator 105, when the local node setting information 231 mismatches the values concerning the local server node 2, the values being included in the foreign node setting information 232 received from each associated server node 2, the setting information to be selected as the local node setting information 231 is determined in the following manner.

Specifically, the local node setting information manager 104 selects majority setting information that matches the largest number of pieces of the setting information as a result of the comparison between the setting information stored as the local node setting information 231 and multiple pieces of setting information stored as the foreign node setting information 232. This means that if values related to the local server node 2 contained in the multiple pieces of setting information received from the respective server nodes 2 do not match, the local node setting information manager 104 selects majority setting information as the local node setting information 231 (i.e., determination on the majority basis).

Then if the selected majority setting information is different from the setting information stored as the local node setting information 231 in the local non-volatile memory 23, the local node setting information manager 104 determines the selected majority setting information as the local node setting information 231.

FIGS. 8A-8D are diagrams illustrating an example of the manner of verifying the local node setting information 231 by the local node setting information manager 104 in the computer system 1 of the first embodiment.

FIGS. 8A-8D focus on verification of the local node setting information 231 in a server node 2 having an ID=2, (which will be referred to as the server node #2) and assumes that the server nodes 2 having IDs=1, 3 (hereinafter respectively referred to as the server node #1 and the server node #3) are the associated server nodes 2 with the server node #2.

The local node setting information manager 104 of the sever node #2 compares the setting information stored as the local node setting information 231 in the local non-volatile memory 23 and the setting information related to the sever node #2 stored as the foreign node setting information 232 in each of the sever node #1 and the sever node #3.

In the drawings, the server node 2 having an ID=2 is represented by “local node” and the server nodes 2 having IDs=1, 3 are represented by “associated server node #1” and “associated server node #3”, respectively.

In the example of FIG. 8A, the setting information that the sever node #2 (local node) retains as the local node setting information 231 entirely (perfectly) matches the setting information related to the sever node #2 that the sever node #1 and the sever node #3 retain as the foreign node setting information 232.

In this case, the local node setting information manager 104 of the sever node #2 selects the local node setting information 231 retained in the local node as the local node setting information 231.

In the example of FIG. 8B, the setting information that the sever node #2 (local node) retains as the local node setting information 231 matches the setting information related to the sever node #2 that the sever node #1 retains as the foreign node setting information 232. In contrast, the setting information that the sever node #2 (local node) retains as the local node setting information 231 mismatches the setting information related to the sever node #2 that the sever node #3 retains as the foreign node setting information 232 (partial mismatch).

Namely, the setting information related to the sever node #2 that the sever node #1 retains as the foreign node setting information 232 mismatches the setting information related to the sever node #2 that the sever node #3 retains as the foreign node setting information 232.

In this case, the local node setting information manager 104 of the sever node #2 selects, on the majority basis, the local node setting information 231 that is retained in the local node and that matches the largest number of pieces of the setting information (i.e., the majority setting information) as the local node setting information 231.

In the example of FIG. 8C, the setting information that the sever node #2 (local node) retains as the local node setting information 231 mismatches the setting information related to the sever node #2 that the sever node #1 retains as the foreign node setting information 232. In addition, the setting information that the sever node #2 (local node) retains as the local node setting information 231 mismatches the setting information related to the sever node #2 that the sever node #3 retains as the foreign node setting information 232.

However, the setting information related to the sever node #2 that the sever node #1 retains as the foreign node setting information 232 matches the setting information related to the sever node #2 that the sever node #3 retains as the foreign node setting information 232 (partial mismatch).

In this case, the local node setting information manager 104 of the sever node #2 selects, on the majority basis, the setting information related to the sever node #2 that is retained as the foreign node setting information 232 in the sever node #1 (#3) and that matches the largest number of pieces of the setting information (majority setting information) as the local node setting information 231.

In the example of FIG. 8D, the setting information that the sever node #2 (local node) retains as the local node setting information 231 mismatches the setting information related to the sever node #2 that the sever node #1 retains as the foreign node setting information 232. In addition, the setting information that the sever node #2 (local node) retains as the local node setting information 231 mismatch thees setting information related to the sever node #2 that the sever node #3 retains as the foreign node setting information 232.

Furthermore, the setting information related to the sever node #2 that the sever node #1 retains as the foreign node setting information 232 mismatches the setting information related to the sever node #2 that the sever node #3 retains as the foreign node setting information 232.

In this case, the local node setting information manager 104 of the sever node #2 selects the local node setting information 231 retained in the local node as the local node setting information 231.

The foreign node setting information manager 103 manages the foreign node setting information 232, which is a copy of the setting information related to each associated server node 2 with the server node 2 (local server node 2) that includes the BMC 10 on which the foreign node setting information manager 103 in question functions.

For example, the foreign node setting information manager 103 stores foreign node setting information 232 in a predetermined region of the non-volatile memory 23. Upon receipt of, from a foreign server node 2, a request for transmitting foreign node setting information 232, the foreign node setting information manager 103 reads the requested foreign node setting information 232 from the non-volatile memory 23 and transmits the read information 232 to an associated server node 2 via the data transmission controller 106.

This can share the foreign node setting information 232. For example, in cases where an associated server node 2 is to be replaced for system failure or another reason, the setting information of the removed associated server node 2 is transmitted to the replacement server node 2, so that the server node 2 can function likewise the function before the replacement.

Accordingly, the foreign node setting information manager 103 functions as a second setting information manager that controls storing of a copy of the setting information of each associated server node 2 among the multiple server nodes 2 into the local non-volatile memory 23.

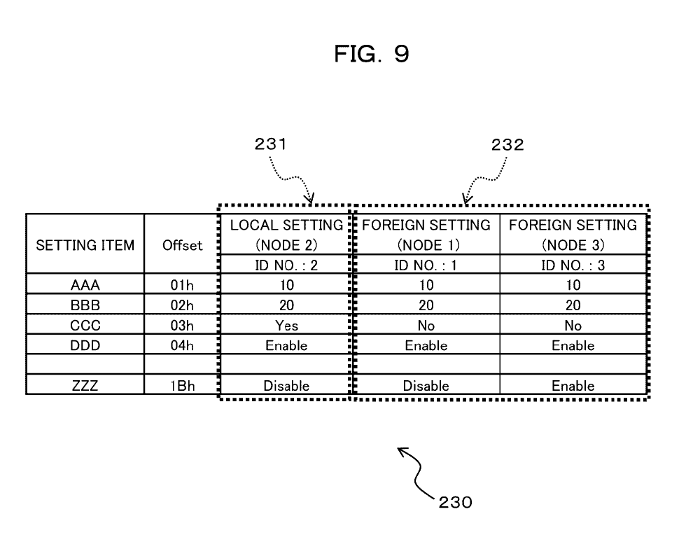

FIG. 9 is a diagram illustrating an example of local node setting information 231 and foreign node setting information 232 in the computer system 1 of the first embodiment. In the example of FIG. 9, node setting information 230 represents the combination of the local node setting information 231 and the foreign node setting information 232.

As illustrated in FIG. 9, the node setting information 230 includes the management items of setting item, Offset, local setting, and foreign setting. The example of FIG. 9 illustrates the node setting information 230 (the local node setting information 231 and the foreign node setting information 232) of the server node 2 having an ID=2.

A setting item is a kind of the setting information and is managed by the BIOS or the firmware. A value representing the setting information is prepared for each setting item. An offset represents a position where the corresponding setting item of the setting information is stored. For example, the offset represents the position where a setting item of the setting information is stored in the non-volatile memory 23 with a distance from a predetermined reference point.

The local setting represents the values set for the setting information related to the local server node 2. For example, for the server node 2 having an ID=2, the values of the setting information of the local server node 2 (i.e., node #2) are registered as the local setting.

The foreign setting represents the values set for an associated server node 2. In the computer system 1 of the first embodiment, two server nodes 2 are set to be associated server nodes 2 with each server node 2, and two pieces of foreign setting are registered in the example of FIG. 9.

The node setting information 230 in the example of FIG. 9 concerns the server node 2 having an ID=2, and further includes, as two pieces of the foreign setting, setting information of the server node 2 (node #1) having an ID=1 and that of the server node 2 (node #3) having an ID=3.

For example, a setting item CCC of the setting information is stored in the offset position “04h” and is set to be “Yes” for the node #2 (local server node 2) and “No” for the node #1 and the node #3.

The setting item, the offset, and the local setting in the node setting information 230 correspond to the local node setting information 231 while the setting item, the offset and foreign setting in the node setting information 230 correspond to the foreign node setting information 232.

(B) Operation:

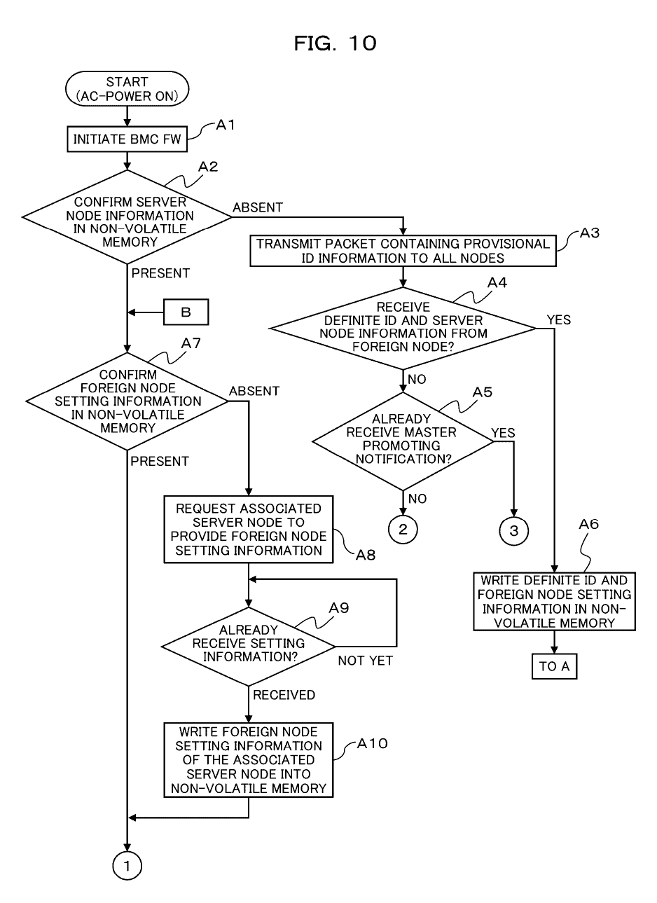

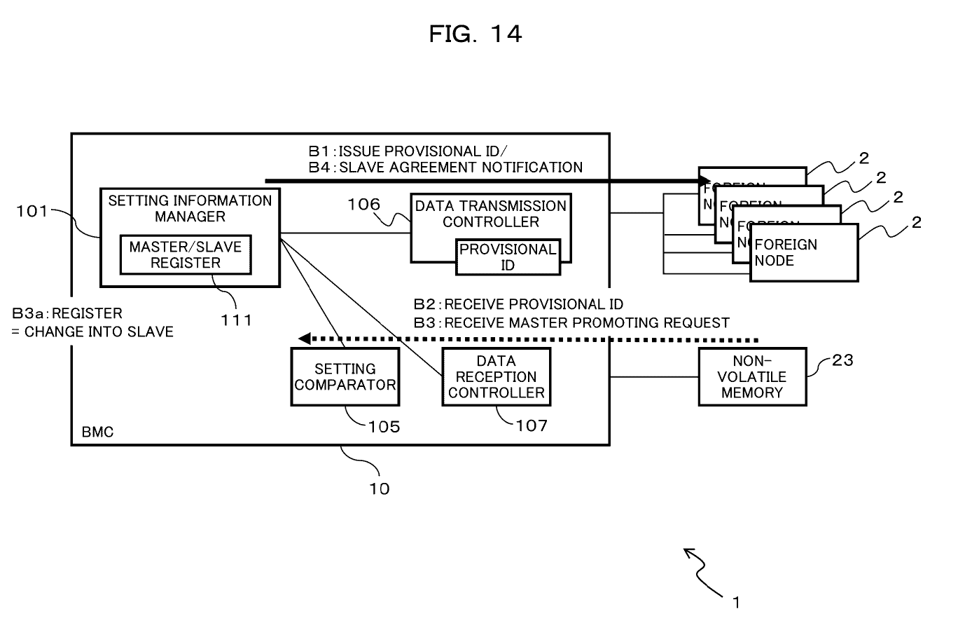

Next, description will now be made in relation to a process performed by the BMC 10 in the computer system 1 of the first embodiment having the above configuration along the flow diagrams FIGS. 10-13 (steps A1-A47) with reference to FIGS. 14-23.

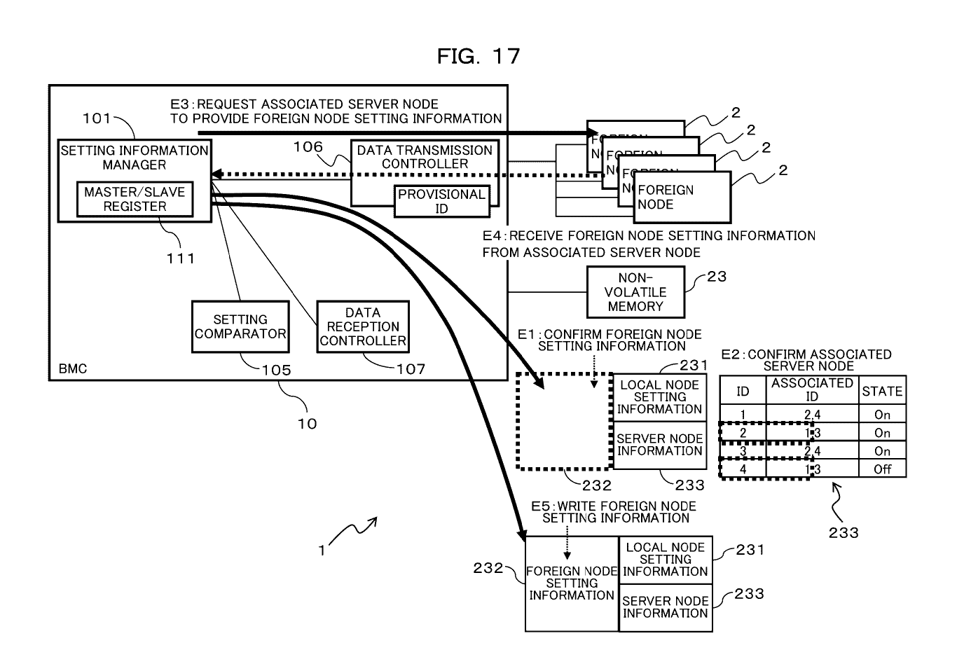

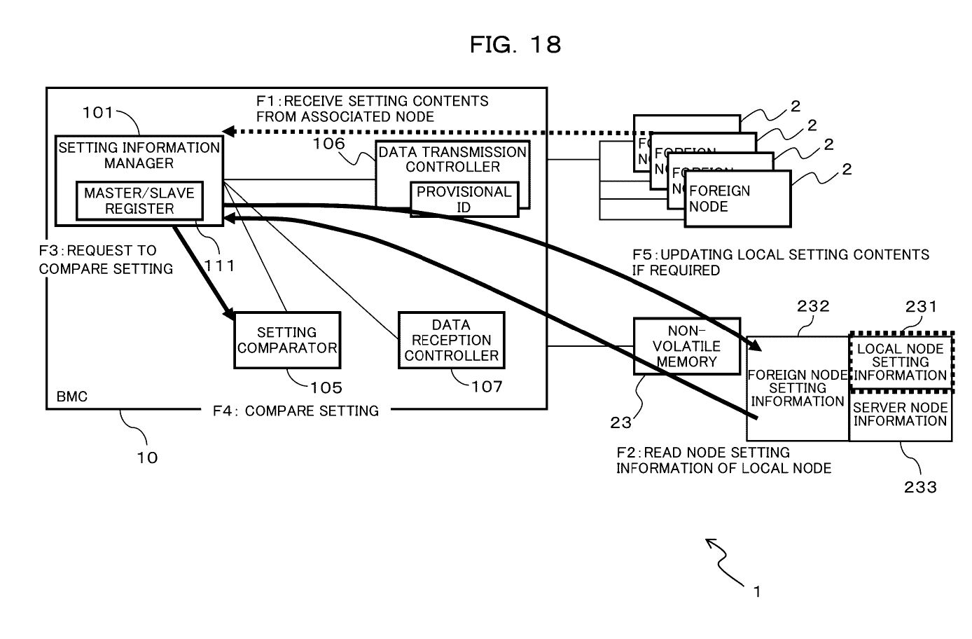

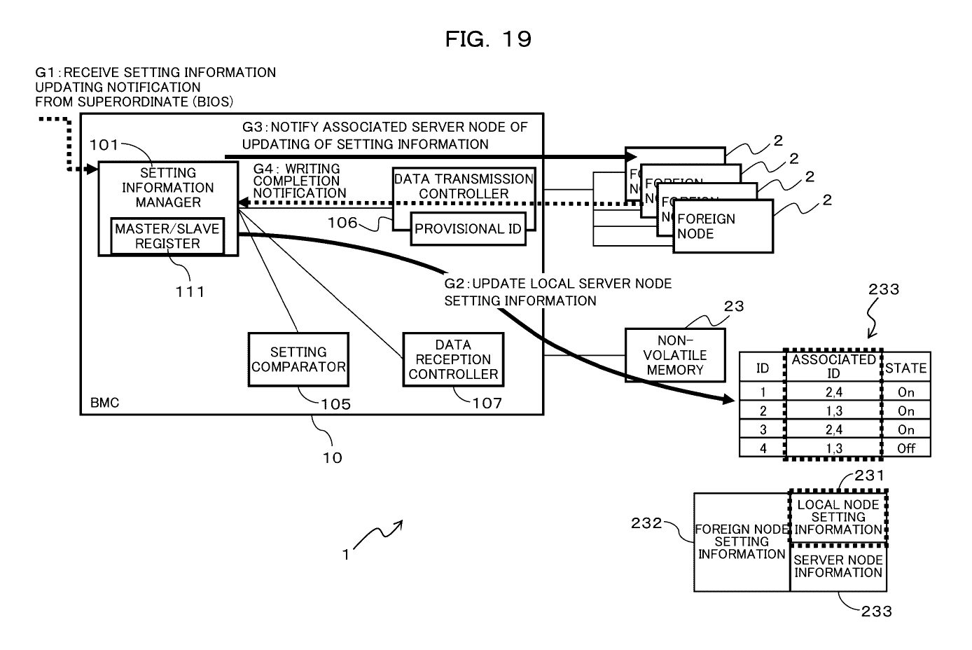

FIGS. 14-22 are diagrams each illustrating a flow of data received and transmitted in the BMC 10 of the computer system of an example of the first embodiment, in particular, FIGS. 14-16 illustrate data flow in updating the server node information 233. FIG. 17 illustrates data flow in updating the foreign node setting information 232; FIG. 18 illustrates data flow in confirming the local node setting information 231; and FIG. 19 illustrates data flow in a process when the local node setting information 231 has been updated.

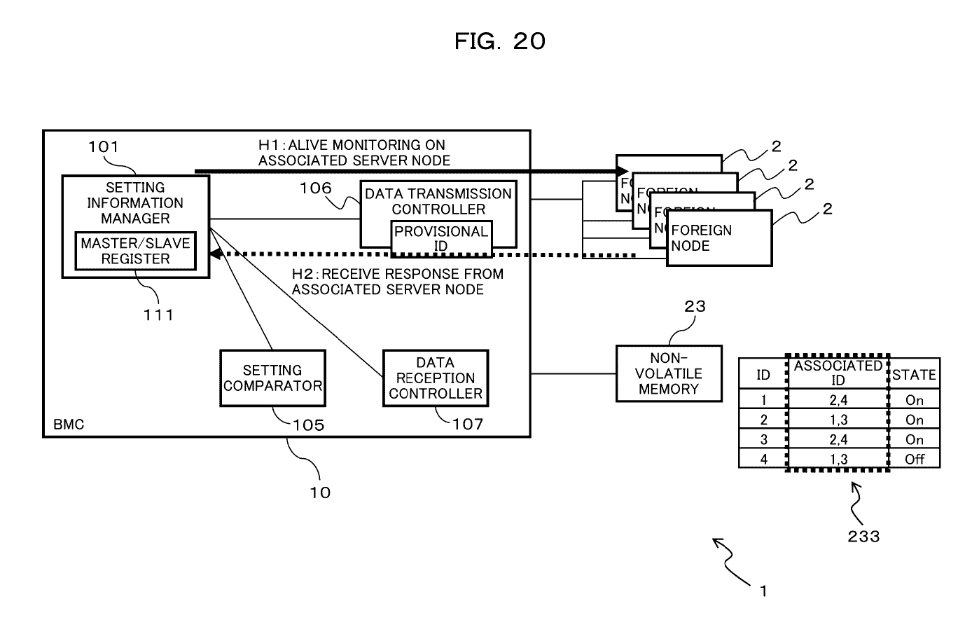

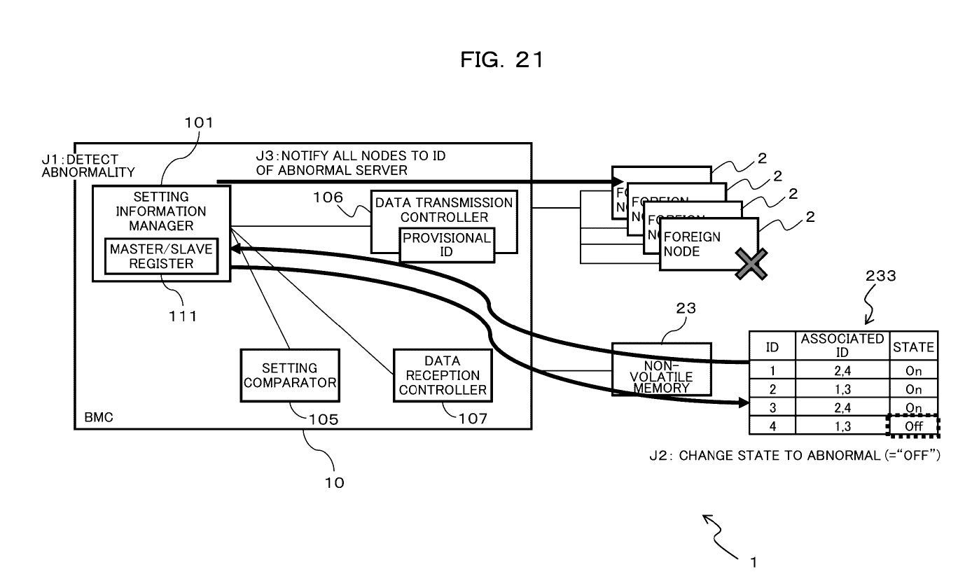

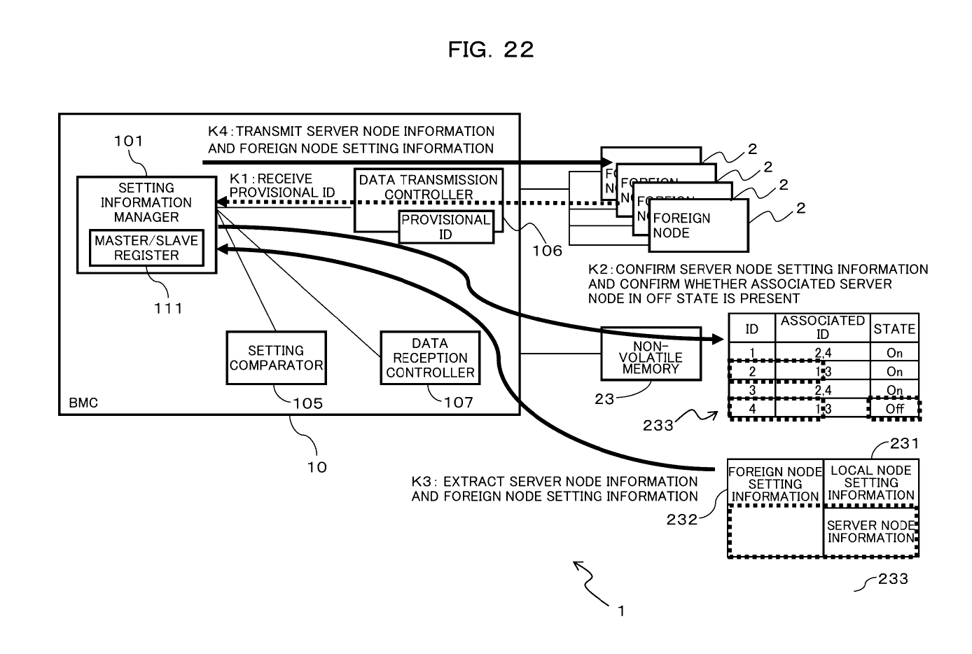

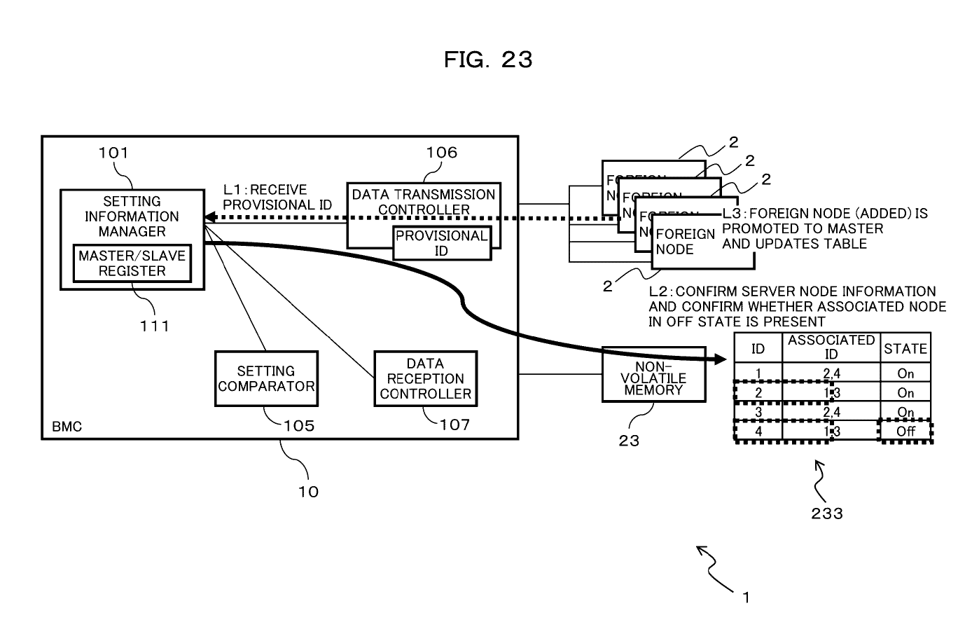

FIGS. 20 and 21 illustrate data flow in alive monitoring, in particular, FIG. 21 illustrates data flow in cases where alive monitoring detects an abnormal state. Furthermore, FIG. 22 illustrates data flow in replacing a server node 2, and FIG. 23 illustrates data flow in increasing a server node 2.

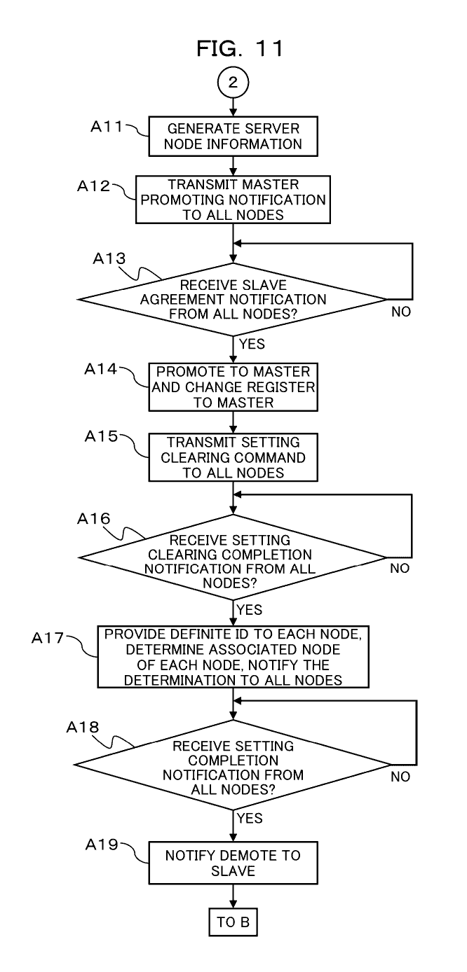

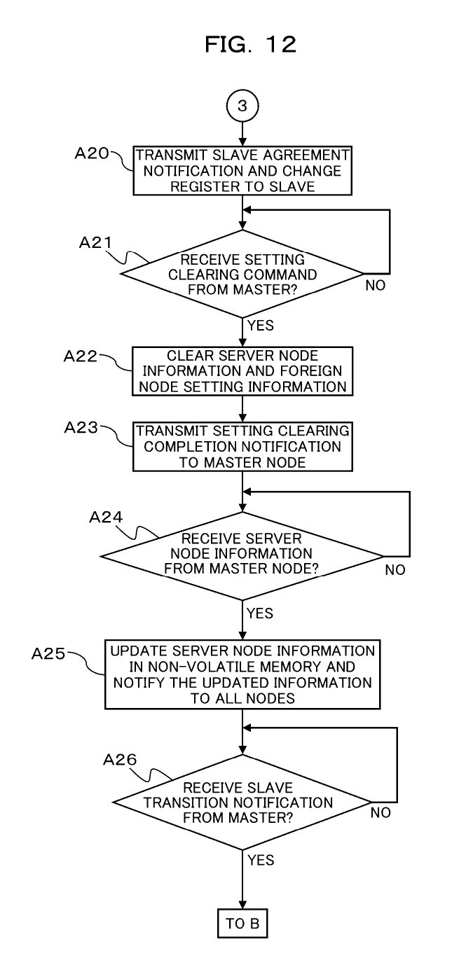

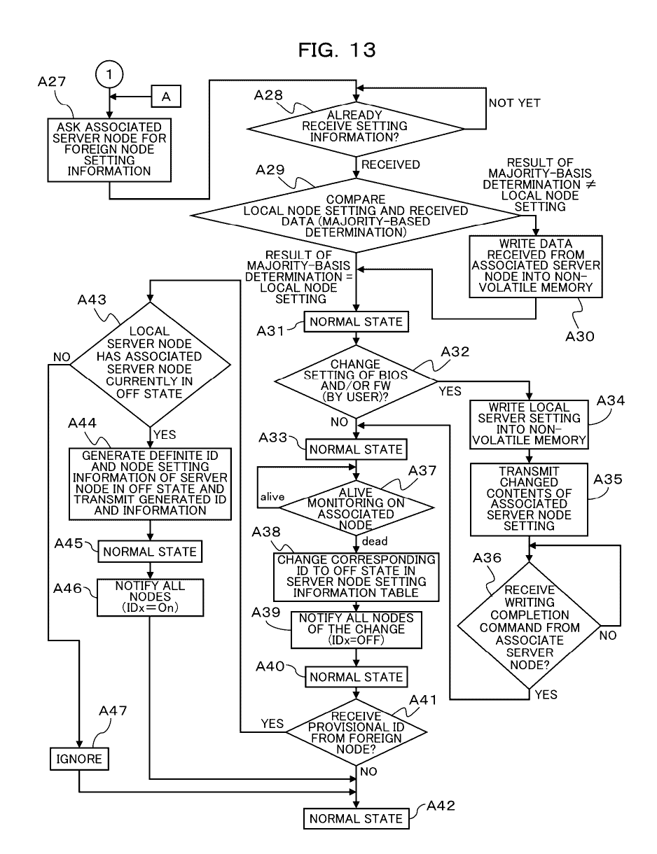

FIG. 10 illustrates a process of steps A1-A10; FIG. 11 illustrates a process of steps A11-A19; FIG. 12 illustrates a process of steps A20-A26; and FIG. 13 illustrates a process of steps A27-A47.

After the AC power source is turned on in the computer system 1, the initialization of the firmware (FW) of the BMC 10 is started (step A1 of FIG. 10). The server node information manager 102 confirms the content of the server node information 233 stored in the non-volatile memory 23 via the data transmission controller 106 (step A2 of FIG. 10), so that the server node information manager 102 confirms whether the server node information 233 retains valid information.

As a result of the confirmation, in cases where valid information is absent from the server node information 233 (see the “ABSENT” route in step A2), the server node information manager 102 starts updating the server node information 233 in the initialization stage.

Under this state, not retaining information about the configuration of the server nodes 2 accommodated in the same casing 3, the server node information manager 102 does not grasp the presence of a server node 2 retaining valid server node information 233 in the casing 3. For the above, the server node information manager 102 issues a request for searching a server node 2 retaining the valid server node information 233 via the data transmission controller 106 (issuing a request for obtaining the server node information 233).

The data transmission controller 106 transmits a provisional ID packet provided with, as identification information, a provisional ID that the data transmission controller 106 retains beforehand to all the server nodes 2 accommodated in the casing 3 (see step A3 of FIG. 10, steps B1 and B2 in FIG. 14).

The server node information manager 102 confirms whether the server node information manager 102 has received the definite ID (not provisional ID) of each server node 2 of the transmission source and the server node information 233 in response to the issued request for obtaining the server node information 233 (step A4 of FIG. 10).

As a result of the confirmation, when the server node information manager 102 is not replied from any server node 2, that is, does not receive a definite ID and server node information 233 (see “NO” route in step A4), it can be estimated that the foreign server nodes 2 are all in initialization state. The server node information manager 102 starts the procedure to promote the local server node 2 to a master node in order to update the server node information 233 concerning the foreign server nodes 2 as well as the local server node 2.

The server node information manager 102 confirms whether the server node information manager 102 has received master promoting notification from a server node information manager 102 of a foreign server node 2 (step A5).

When the server node information manager 102 does not receive the master promoting notification and also when the foreign server nodes 2 are in the initialization state (see NO route in step A5), the foreign server nodes 2 issues respective provisional ID packets and the server node information manager 102 collects the provisional ID packets issued from the foreign server nodes 2 via the data reception controller 107 (see reference number B2 in FIG. 14) and generates provisional server node information 233a (step A11 of FIG. 11). The server node information manager 102 grasps the configuration (the number) of server nodes 2 accommodated in the casing 3 of the computer system 1 on the basis of the number of transmission sources of received provisional ID packets.

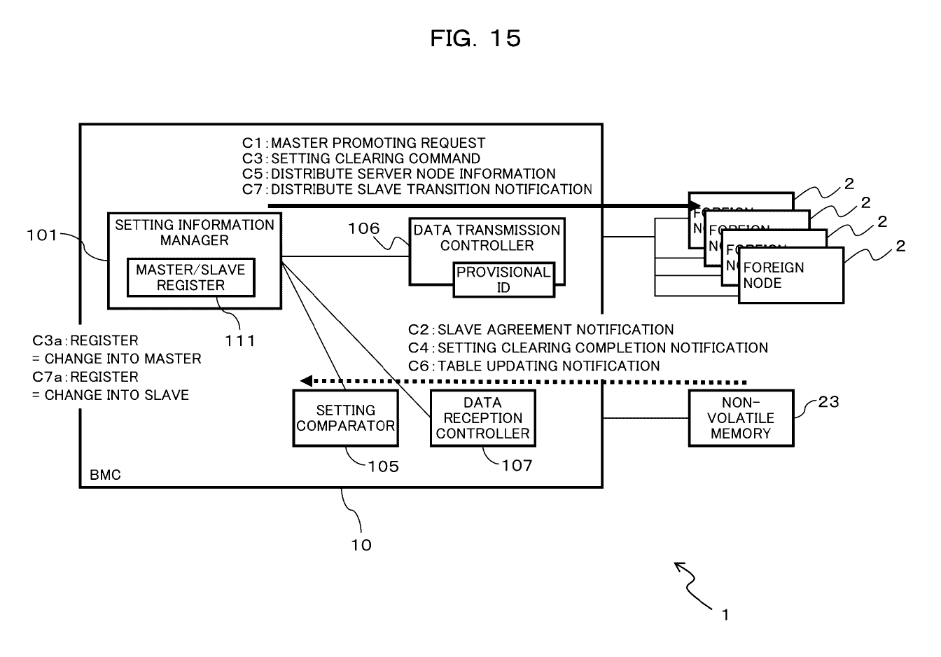

When not receiving master promoting notification for a predetermined time period, the server node information manager 102 issues a request that declares promotion to the master node to all the server nodes 2 via the data transmission controller 106 (step A12 of FIG. 11; see reference number C1 in FIG. 15).

The server node information manager 102 confirms whether the server node information manager 102 has received slave agreement notification from all the server nodes 2 registered in the provisional server node information 233a (step A13 of FIG. 11). In cases where the server node information manager 102 has not received slave agreement notification from all the server nodes 2 (see NO route in step A13), the server node information manager 102 repeatedly carries out step A13.

Upon receipt of the slave agreement notification from all the server nodes 2 (see YES route in step A13; and see reference number C2 in FIG. 15), the server node information manager 102 promotes the local server node 2 to a master node and sets a value indicating that the local server node 2 is to function as a master node into the master/slave register 111 (step A14 of FIG. 11: see reference number C3a in FIG. 15).

After promoting the local server node 2 to the master node, the server node information manager 102 of the master server node 2 issues a setting clearing command to all the server nodes 2 via the data transmission controller 106 (step A15 of FIG. 11; see reference number C3 in FIG. 15). The setting clearing command instructs each slave server node 2 to clear the server node information 233 and the foreign node setting information 232 retained in the slave server node 2.

Upon receipt of the setting clearing command, a server node 2 clears the server node information 233 and the foreign node setting information 232 being stored therein. Upon completion of clearing the server node information 233 and the foreign node setting information 232, the server node 2 notifies completion of clearing the setting to the master server node 2.

In the master server node 2, the server node information manager 102 confirms whether the server node information manager 102 has received notification of completion of clearing the setting from all the server nodes 2 registered in the provisional server node information 233a (step A16 of FIG. 11).

In cases where the server node information manager 102 has not received notification of completion of clearing the setting from all the server nodes 2 (see NO route in step A16), the server node information manager 102 repeatedly carries out step A16.

In cases where the server node information manager 102 has received notification of completion of clearing the setting from all the server nodes 2 (see YES route in step A16; see reference number C4 in FIG. 15), the server node information manager 102 of the master server node 2 provides a definite ID (ID information) to each provisional ID and sets one or more associated IDs for the ID. This means that the server node information manager 102 determines associated server nodes 2 with each server node 2 in which associated server nodes 2 are to store therein the setting information of the server node 2, and generate the server node information 233.

The server node information manager 102 of the master server node 2 notifies all the server nodes 2 accommodated in the computer system 1 of the generated server node information 233 via the data transmission controller 106 (step A17 in FIG. 11; see reference number C5 in FIG. 15).

The server node information manager 102 of the master server node 2 confirms whether the server node information manager 102 has received notification of completion of setting the server node information 233 from all the server nodes 2 included in the computer system 1 (step A18 of FIG. 11).

If the server node information manager 102 has not received the notification of completion of the setting from all the server nodes 2 (see NO route in step A18), the server node information manager 102 repeatedly carries out step A18.

Upon confirmation of the notification of completion of the setting from all the server nodes 2 (see YES route in step A18; see reference number C6 in FIG. 15), the server node information manager 102 of the master server node 2 demotes the master server node 2 to a slave server node. Specifically, the server node information manager 102 of the master server node 2 changes the value in the master/slave register 111 to one that indicating that the local server node 2 is to function as a slave node (see reference number C7a in FIG. 15).

The server node information manager 102 of the master server node 2 notifies the foreign server nodes 2 that the master server node 2 is demoted to a slave node (slave transition notification) (step A19 of FIG. 11; see reference number C7 in FIG. 15), the process moves to step A7 of FIG. 10.

When a server node 2 receives, from a foreign server node 2, a request that declares that the foreign server node 2 promotes itself to a master node (see YES route in step A5; see reference number B3 in FIG. 14), the server node 2 is not promoted to a master node and does function as a slave node. The server node information manager 102 of the server node 2 sets a value that indicating that the local server node 2 is to function as a slave node in the master/slave register 111 (see reference number B3a in FIG. 14). The server node information manager 102 transmits slave agreement notification to the foreign server node 2 as the agreement to function as a slave server node 2 (step A20 in FIG. 12; see reference number B5 in FIG. 14).

After that, the server node information manager 102 of the slave server node 2 confirms whether the server node information manager 102 has received a setting clearing command (request) related to the foreign node setting information 232 and the server node information 233 from the master server node 2 (step A21 of FIG. 12). When not receiving the setting clearing command (request) from the master server node 2 (see NO route in step A21), the server node information manager 102 repeats the process of step A21 to wait for receiving the setting clearing command.

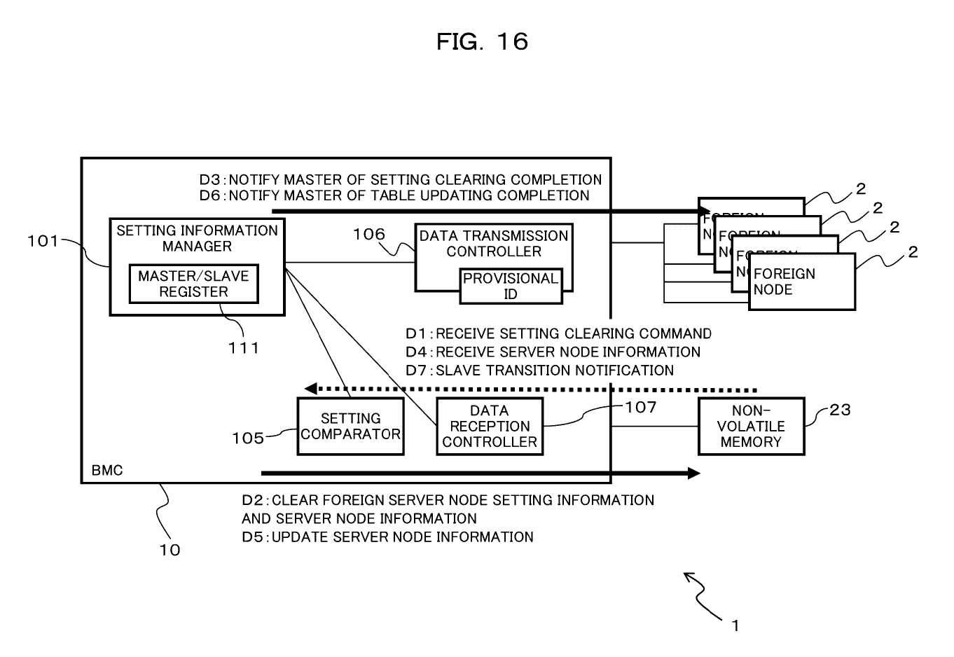

When receiving the setting clearing command (request) from the master server node 2 (see YES route in step A21; see reference number D1 in FIG. 16), the server node information manager 102 of a slave server node 2 clears the server node information 233 and the foreign node setting information 232 stored in the local non-volatile memory 23 (step A22 of FIG. 12; see reference number D2 in FIG. 16). Upon completion of clearing the two pieces of information, the server node information manager 102 issues notification of completion of clearing the setting to the master server node 2 (step A23 of FIG. 12; see reference number D3 in FIG. 16).

After that, the server node information manager 102 of each slave server node 2 confirms whether the server node information manager 102 has received server node information 233 from the master server node 2 (step A24 of FIG. 12).

If not receiving the server node information 233 from the master server node 2 (see NO route in step A24), the server node information manager 102 repeats the process of step A24.

Upon receipt of the server node information 233 from the master server node 2 (see YES route in step A24; see reference number D4 in FIG. 16), the server node information manager 102 of the slave server node 2 changes the server node information 233 being stored in the non-volatile memory 23 with the values in the received server node information 233 (see reference number D5in FIG. 16). Then, the 102 the server node information manager 102 reports the completion of updating the server node information 233 to the master server node 2 (see step A25 of FIG. 12; reference number D6 in FIG. 16).

The server node information manager 102 of the slave server node 2 confirms whether the server node information manager 102 has received the slave transition notification from the master server node 2 (step A26 of FIG. 12).

If not receiving the slave transition notification from the master server node 2 (see NO route in step A26), the server node information manager 102 repeats the process of step A26.

Upon receipt of the slave transition notification from the master server node 2 (see YES route in step A26; see reference number D7 in FIG. 16), the process moves to step A7 of FIG. 10.

In step A7 of FIG. 10, the foreign node setting information manager 103 confirms the foreign node setting information 232 stored in the local non-volatile memory 23 to confirm whether valid data (setting information) is stored in the foreign node setting information 232 (see reference number E1 in FIG. 17).

If the valid data is absent in the foreign node setting information 232 as a result of the confirmation (see “ABSENT” route in step A7), the foreign node setting information manager 103 confirms its associated server nodes 2 by reference to the server node information 233 (see reference number E1 in FIG. 17). Then, the foreign node setting information manager 103 requests each associated server nodes 2 to provide the foreign node setting information 232 (see step A8 of FIG. 10; reference number E3 in FIG. 17).

The foreign node setting information manager 103 confirms whether the foreign node setting information manager 103 has received foreign node setting information 232 from the associated server node 2 (step A9 of FIG. 10).

If not receiving foreign node setting information 232 from the associated server node 2 (see “NOT YET” route in step 9), the foreign node setting information manager 103 repeats the process of step A9.

Upon receipt of the foreign node setting information 232 from the associated server node 2 (see “RECEIVED” route in step A9; see reference number E4 in FIG. 17), the foreign node setting information manager 103 stores the received foreign node setting information 232 into the non-volatile memory 23 (see step A10 of FIG. 10; reference number E5 in FIG. 17).

This means that the process of steps A7-A10 of FIG. 10 corresponds to a process of updating the foreign node setting information 232 by the foreign node setting information manager 103.

After that, the process moves to step A27 of FIG. 13. If the valid data is present in the foreign node setting information 232 as a result of the confirmation in step A7 (see “PRESENT” route in step A7), the process also moves to step A27 of FIG. 13. The process in and subsequent to step A27, the computer system 1 moves into a normal operation phase (normal operation stat).

In the normal operation phase, the local node setting information manager 104 determines whether the local node setting information 231 is correct while, for example, the computer system 1 is being started or restarted.

Specifically, in step A27 of FIG. 13, the local node setting information manager 104 asks each associated server node 2 for foreign node setting information 232 by reference to the server node information 233.

Then, the local node setting information manager 104 confirms whether the local node setting information manager 104 has received the foreign node setting information 232 from each associated server node 2 (step A28 of FIG. 13).

If not receiving the foreign node setting information 232 from each associated server node 2 (see “NOT YET” route in step A28), the local node setting information manager 104 repeats the process of step A28.

Upon receipt of the foreign node setting information 232 from each associated server node 2 (see “RECEIVED” route in step A28; reference number F1 in FIG. 18), the local node setting information manager 104 reads the values of the local node setting information 231 stored in the local non-volatile memory 23 (see reference number F2 in FIG. 18).

Then, the local node setting information manager 104 requests the setting comparator 105 (see reference number F3 in FIG. 18) to compare the values in the received foreign node setting information 232 concerning the local server node 2 with the values in the local node setting information 231 stored in the non-volatile memory 23 (step A29 of FIG. 13; see reference number F4 in FIG. 18).

In cases where the comparison detects a difference in the setting, the local node setting information manager 104 determines majority data (setting information) to be selected as the local node setting information 231. In detail, the local node setting information manager 104 selects majority setting information determined by the comparison among the values in each piece of the received foreign node setting information 232 concerning the local server node 2 and the values of the local node setting information 231 stored in the non-volatile memory 23.

If the values of the local node setting information 231 do not match the values of the majority setting information obtained by the comparison (see “Result of majority-basis determination≠local node setting” route in step A29), the local node setting information manager 104 stores the values of the majority setting information received from two or more associated server nodes 2, as the values the local node setting information 231, into the non-volatile memory 23 (step A30 of FIG. 13). This means that the local node setting information 231 is updated with the majority setting information received from two or more associated server nodes 2 (see reference number F5 in FIG. 18).

In contrast, if the values of the local node setting information 231 match the values of the majority setting information obtained by the comparison (see “Result of majority-basis determination=local node setting” route in step A29), the local node setting information manager 104 does not modify the values of the local node setting information 231 and moves the process to step A31 of FIG. 13, so that the computer system 1 is made into the normal operation state.

In the normal operation state, the local node setting information manager 104 confirms whether the BIOS and/or the firmware (FW) has been changed by, for example, user operation (see step A32 of FIG. 13).

In cases where the BIOS and the firmware has not been changed (see NO route of step A32), the process moves to step A33 where the computer system 1 is made into the normal operation state.

On the other hand, in cases where the local node setting information 231 has been changed (see YES route in step A32), the local node setting information manager 104 receives setting information updating notification from a superordinate entity, such as the BIOS (see reference number G1 in FIG. 19).

Then, the local node setting information manager 104 writes the updated data (setting information) into the non-volatile memory 23 (step A34 in FIG. 13; see reference number G2 in FIG. 19). Concurrently with the above, the local node setting information manager 104 transmits the changed contents of the setting information to each associated server node 2 based on the server node information 233 (see step A35 in FIG. 13; reference number G3 in FIG. 19).

The local node setting information manager 104 confirms whether the local node setting information manager 104 has received a writing completion command that notifies the completion of updating the setting information from each associated server node 2 (step A36 of FIG. 13).

In cases where the writing completion command has not been received from each associated server node 2 (see NO route in step A36; see reference number G4 in FIG. 19), the local node setting information manager 104 repeats the process of step A36.

In cases where the writing completion command is received from each associated server node 2 (see YES route in step A36), the process moves to step A33 of FIG. 13 where the computer system 1 is made into the normal operation state.

In the normal (operation???) state, the server node information manager 102 performs alive monitoring on each associated server node 2 by reference to the server node information 233 (step A37 of FIG. 13; see reference number H1 of FIG. 20). In other words, the server node information manager 102 determines whether each associated server node 2 is normally operating (alive) or stopped (dead).

The server node information manager 102 transmits, for example, a command to each associated server node 2. If the associated server node 2 responds to the transmitted command, the associated server node 2 is determined to be in a normal state. In contrast, if the associated server node 2 does not respond to the transmitted command, the associated server node 2 is determined to be in an abnormal state.

If each associated server node 2 responds to the transmitted command (see reference number H2 in FIG. 20), which means that each associated server node 2 is operating (see “ALIVE” route in step A37), the server node information manager 102 repeats the process of step A37.

If an abnormal state of an associated server node 2 is detected (see “DEAD” route in step A37; see reference number J1 in FIG. 21), the server node information manager 102 changes the value of the state associated with the ID of the associated server node 2 to “OFF”, which means the abnormal state, in the server node information 233 (step A38 of FIG. 13; see reference number J2 in FIG. 21).

In addition, the server node information manager 102 transmits state changing notification (e.g., “IDx=Off”) containing the ID of an associated server node 2 in an abnormal state to all the server nodes 2 accommodated in the casing 3 (step A39 in FIG. 13; see reference number J3 in FIG. 21). Upon receipt of the state changing notification, each server node 2 updates the local server node information 233 that is managed therein to agree with the received state changing notification. Then, the process moves to step A40 in FIG. 13 and the computer system 1 is made in the normal operation state.

In addition to the above, a foreign server node 2 may have a failure in the normal operation state and therefore be replaced another server node 2.

In the above case, the replacement server node 2 does not retain the server node information 233, the operation of the initialization phase in above step A7 in FIG. 10 is to be carried out.

For this purpose, the server node 2 may sometimes receive a provisional ID from a foreign server node 2 while the computer system 1 is operating. In other words, the server node information manager 102 confirms whether the server node information manager 102 has received a provisional ID from a foreign server node 2 (step A41 of FIG. 13).

If receiving the provisional ID (see YES route in step A41; see reference number K1 in FIG. 22), the server node information manager 102 confirms, by referring to the server node information 233 stored in the non-volatile memory 23, whether an associated server node 2 in the “Off” state is present (step A43 of FIG. 13; see reference number K2 in FIG. 22).

In cases where the server node information 233 indicates the presence of an associated server node 2 in the “Off” state (see YES route in step A43), the server node information manager 102 reads the server node information 233 and the foreign node setting information 232 from the non-volatile memory 23 (see reference number K3 in FIG. 22).

Then the server node information manager 102 sets the ID of the associated server node 2 in the Off state to be the definite ID of the server nodes 2 that has issued a provisional ID. This means that the server node information manager 102 determines that the associated server node 2 being in the abnormal state is replaced with another server node 2 in maintenance and allocates the ID of the removed associated server node 2 to the replacement server node 2.

The server node information manager 102 transmits the server node information 233 and the foreign node setting information 232 along with the definite ID to the server nodes 2 that has issued the provisional ID (step A44 of FIG. 13; see reference number K4 in FIG. 22).

Upon received the server node information 233 and the foreign node setting information 232 along with the definite ID, the server nodes 2 that has issued the provisional ID stores (reflects) the values of the received server node information 233 and foreign node setting information 232 into the non-volatile memory 23. In addition, the server nodes 2 that has issued the provisional ID changes the own state in the server node information 233 to “On (normal)”, and consequently, the computer system 1 comes into the normal operation state (step A45 of FIG. 13).

The server nodes 2 that has issued the provisional ID notifies all the server nodes 2 of a signal indicating that the server node 2 is in “On (normal)” state (step A46 of FIG. 13). The succession of the above steps completes replacing of the server node 2 in the computer system 1.

After that, the process returns to step A42 and the process in and subsequent to step A31 is repeated as the normal operation phase. If not receiving a provisional ID as a result of the confirmation in step A41 in FIG. 13 (see NO route in step A41), the process moves to step A42.

In cases where the server node information 233 indicates the absence of an associated server node 2 in the “Off” state as a result of the confirmation in step A43 (NO route in step A43; see reference number L2 in FIG. 23), it is considered that the computer system 1 increases another server node 2, which is sometimes referred to as “newly-added server node 2.

In this case, the server node information manager 102 of each server node 2 already existed in the computer system 1 ignores the reception of the provisional ID (step A47 in FIG. 13). After that, the process moves to step A42.

In the newly-added server node 2 executes the process in and subsequent to step A1 of FIG. 10, which is started when the server node 2 is activated.

In this case, since each already-exiting server node 2 does not retain the information about the newly-added server node 2, the process moves to step A1-A3 and the provisional ID is issued in step A3 (see reference number L1 of FIG. 23). After that, the process moves to steps A7-A9, and A11 and the newly-added server node 2 is promoted to a master node (see reference number L3 in FIG. 23). Then, the newly-added server node 2 updates the server node information 233 therein, so that the setting information of all the server nodes 2 accommodated in the casing 3 is updated.

If receiving a definite ID and the server node information 233 from a foreign server node 2 as a result of the confirmation in step A4 of FIG. 10 (see YES route in step A4), the server node information manager 102 writes the received definite ID and server node information 233 into the non-volatile memory 23 (step A6 of FIG. 10), so that the computer system 1 completes increase the additional server node 2 and moves to step A27 (see reference symbol A) to come into the normal operation mode.

(C) Effects:

The computer system 1 of the first embodiment can dispersedly stores setting information of a server node 2 by storing a copy of the setting information in one or more associated server nodes 2. The copy of the setting information stored in the associated server nodes 2 can be regarded as a backup of the setting information. If a server node 2 is replaced for maintenance purpose, for example, the replacement server node 2 can be rapidly restored by using the backup of the setting information stored in the associated server nodes 2.

This can eliminate the need for reserving, in a particular server node 2, a large-capacity non-volatile memory having a memory region to store the setting information of all the server nodes 2 accommodated in the computer system 1. Advantageously, the hardware cost can be reduced.

Associating two or more server nodes 2 with a single server node 2 can redundantly back up the setting information.

In cases where the server node information 233 is not stored in the local non-volatile memory 23, the server node information manager 102 of the corresponding server node 2 asks an associated foreign server node 2 for providing the server node information 233 via the data transmission controller 106.

Thereby, the server node 2 can obtain the own setting information from an associated foreign server node 2. For example, a server node 2 is replaced with another for maintenance, the replacement server node 2 can be easily made ready to operate.

The server node information manager 102, which updates the item of the “state” in the server node information 233, makes it possible to grasp the state of replacing and increasing a server node 2 in the computer system 1. In addition, alive monitoring and broadcasting state changing notification from a server node information manager 102 that detects an abnormal state as a result of the alive monitoring to all the foreign server nodes 2 make the server node information manager 102 of each server node 2 to actively reconfigure the server node information 233 following to the restoring from a failure or increasing a server node 2.

If the configuration or the setting is modified in a server node 2 to change the setting information thereof, the local node setting information manager 104 transmits the changed setting information to its associated foreign server nodes 2 via the data transmission controller 106 by reference to the server node information 233.

This can reflect the modification in the setting information of the server node 2 in its associated server nodes 2, which back up the setting information.

The local node setting information manager 104 causes the setting comparator 105 to compare the values of the local node setting information 231 stored in the local non-volatile memory 23 with the values of the foreign node setting information 232 received from each associated server node 2. If the value of the local node setting information 231 mismatches the values of the foreign node setting information 232 received from the associated server node 2, the majority setting information among the multiple pieces of the setting information is selected as the local node setting information 231.

This can enhance the reliability of the setting information that is to be set, as the local node setting information 231, in the server node 2.

(D) Others:

Various changes and modifications can be suggested without departing from the spirit of the foregoing embodiment.

For example, the computer system 1 may include two, three, five or more server nodes 2.

In computer system 1 of the above embodiment, a single casing 3 accommodates multiple server nodes 2. However, the configuration of the computer system 1 should by no means be limited to this. A server node 2 disposed outside the casing 3 can be treated likewise the server node 2 accommodated in the casing 3.

Those ordinary skilled in the art can carry out and manufacture the first embodiment by reference to the above disclosure.

The foregoing embodiment can reduce the storage capacity for storing the setting information.

All examples and conditional language recited herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A multi-computer system comprising a plurality of computers including a first computer and a second computer associated with the first computer,
the first computer comprising:
a first setting information manager that controls storing of setting information of the first computer into a memory included in the first computer;
a second setting information manager that controls storing of a copy of setting information of the second computer into the memory; and
an associated information manager that controls storing of association information representing one or more associated computers associated with each of the plurality of computers into the memory.

2. The multi-computer system according to claim 1, wherein:
when the copy of the setting information of the second computer is not stored in the memory, the second setting information manager requests the second computer to transmit the copy of the setting information of the second computer to the first computer by reference to the association information; and stores the copy of the setting information responded from the second computer into the memory.

3. The multi-computer system according to claim 1, wherein:
when the setting information of the first computer is changed, the first setting information manager updates the setting information stored in the memory; and transmits a copy of the setting information after undergoing the changing to the second computer by reference to the association information.

4. The multi-computer system according to claim 1, wherein the first computer is associated with a plurality of the second computers.

5. The multi-computer system according to claim 4, wherein
the first setting information manager:
obtains copies of the setting information of the first computer from the plurality of second computers by reference to the association information;
makes a comparison between the setting information of the first computer stored in the memory and each of the copies of the setting information of the first computer obtained from the plurality of second computers and selects majority setting information as a result of the comparison; and
updates the setting information of the first computer stored in the memory with the majority setting information.

6. A manager for a multi-computer system comprising a plurality of computers including a first computer and a second computer associated with the first computer, the manager being included in the first computer,
the manager comprising:
a first setting information manager that controls storing of setting information of the first computer into a memory included in the first computer;
a second setting information manager that controls storing of a copy of setting information of the second computer into the memory; and
an associated information manager that controls storing of association information representing one or more associated computers associated with each of the plurality of computers into the memory.

7. The manager according to claim 6, wherein:
when the copy of the setting information of the second computer is not stored in the memory, the second setting information manager requests the second computer to transmit the copy of the setting information of the second computer to the first computer by reference to the association information; and stores the copy of the setting information responded from the second computer into the memory.

8. The manager according to claim 6, wherein:
when the setting information of the first computer is changed, the first setting information manager updates the setting information stored in the memory; and transmits a copy of the setting information after undergoing the changing to the second computer by reference to the association information.

9. The manager according to claim 6, wherein the first computer is associated with a plurality of the second computers.

10. The manager according to claim 9, wherein
the first setting information manager:
obtains copies of the setting information of the first computer from the plurality of second computers by reference to the association information;
makes a comparison between the setting information of the first computer stored in the memory and each of the copies of the setting information of the first computer obtained from the plurality of second computers and selects majority setting information as a result of the comparison; and
updates the setting information of the first computer stored in the memory with the majority setting information.

11. A non-transitory computer-readable recording medium having stored therein a managing program to cause a processor in a multi-computer system comprising a plurality of computers including a first computer and a second computer associated with the first computer, the processor being included in the first computer to execute:
storing setting information of the first computer into a memory included in the first computer;
storing a copy of setting information of the second computer into the memory; and
storing of association information representing one or more associated computers associated with each of the plurality of computers into the memory.

12. The non-transitory computer-readable recording medium according to claim 11, wherein the managing program causes the processor to further execute:
when the copy of the setting information of the second computer is not stored in the memory,
requesting the second computer to transmit the copy of the setting information of the second computer to the first computer by reference to the association information, and storing the copy of the setting information responded from the second computer into the memory.

13. The non-transitory computer-readable recording medium according to claim 11, wherein the managing program causes the processor to further execute:
when the setting information of the first computer is changed,
updating the setting information stored in the memory, and transmitting a copy of the setting information after undergoing the changing to the second computer by reference to the association information.

14. The non-transitory computer-readable recording medium according to claim 11, wherein the first computer is associated with a plurality of the second computers.

15. The non-transitory computer-readable recording medium according to claim 14, wherein the managing program causes the processor to further execute:
obtaining copies of the setting information of the first computer from the plurality of second computers by reference to the association information;
comparing between the setting information of the first computer stored in the memory and each of the copies of the setting information of the first computer obtained from the plurality of second computers and selecting majority setting information as a result of the comparing; and
updating the setting information of the first computer stored in the memory with the majority setting information.
